(19) United States
(12) Patent Application Publication
(10) Pub. No.: US 2017/0148347 A1
(43) Pub. Date: May 25, 2017

(54) UTILIZATION OF VIRTUAL MACHINES IN A CYBER LEARNING MANAGEMENT ENVIRONMENT

(71) Applicant: THE KEYW CORPORATION, Hanover, MD (US)

(72) Inventors: Beth M. STINSON, Brookeville, MD (US); Michael A. SCHUMANN, Hanover, MD (US); Catherine M. BUSACK, Bowie, MD (US); Daniel A. WOLFF, Columbia, MD (US); Joseph HARRAH, Pasadena, MD (US); William J. DEL RA, III, Arnold, MD (US); Ty GAST, Pasadena, MD (US); Roland HEMLING, Freeland, MD (US); Matthew J. LOPPATTO, Crofton, MD (US); Brian THOMAS, Charlotte, NC (US)

(21) Appl. No.: 14/947,662

(22) Filed: Nov. 20, 2015

(51) Int. Cl. G09B 19/00; G09B 5/02; G09B 9/00; G06F 9/455

(52) U.S. Cl. CPC G09B 19/0053; G06F 9/45558; G09B 5/02; G09B 9/00; G06F 2009/45595; G06F 2009/4557

(57) ABSTRACT

A cyber-learning environment that utilizes one or more virtual computing environments in order to provide users of a course the ability to simulate computing scenarios without requiring the use of a dedicated machine is provided. The cyber-learning environment can include a core that accepts user inputs, as well as loads pre-defined courses based on the user's identity. The pre-defined courses can be generated by combining one or more assets contained with an asset library. The pre-defined course can also include grading criteria that can be sent to a grading module. The grading module can compare the grading criteria with a user's interaction with the virtual learning environment to assess performance. A score can be generated based on the assessed performance and can be transmitted back to a user of the course thus providing feedback on the user's performance within the course.

### FIELD OF THE DISCLOSURE

This disclosure relates generally to a system that utilizes virtual machines to implement a training environment for instructional courses in which a simulated computing environment can facilitate improved learning. The system can include a core that allows for user interaction with the system as well as loads pre-programmed courses created for the simulated environment, a virtualization platform that takes information from the core and builds the virtual computer or network, and a grading module that builds grading criteria and reviews student performance against the criteria to determine a grade.

### BACKGROUND OF THE DISCLOSURE

Training courses that provide a hands-on learning environment and engage students in real-world scenarios are extremely effective in producing confident and qualified professionals. However, in the areas of cyber security and information technology, training is often text book based and fails to provide a true “hands-on” environment for practicing skills. For instance, in a course that deals with network security, a discussion of network security practices in a text-book may not provide the practical training necessary for a student of the course to be an effective network security administrator in a real-world corporate setting.

However, providing training using practical real-world examples can be costly. In order to facilitate an opportunity to handle real-world computing situations as part of their training, a course administrator may need to build and maintain computers and computer networks so as to provide a “lab” in which real-world situations can be simulated and handled by students as part of their hands-on training. Exacerbating this cost can be the fact that in a class with multiple students, multiple computers and computing networks may need to be maintained in order to provide each and every student with practical experience.

Virtual machines and virtual networks can simulate a computing environment or networks of computers without having to provide the necessary physical hardware that computers and networks require. Providing a platform that allows users to receive hands-on experience and training for information technology and computing classes by utilizing virtual machines and networks can provide the type of hands-on learning environment that can facilitate more in-depth and meaningful training while at the same time not requiring the often expensive physical hardware needed to create real machines and networks.

However, a virtual machine or virtual network in and of itself is often not equipped to provide meaningful interaction between students and their coursework. While virtual machines and virtual networks may provide the simulated environments necessary to achieve a practical training, they may lack the necessary user interfaces to administer the course. A computing system that acts as an interface between stakeholders of a course (i.e., students, instructors, etc.,) and the virtual machine and environment can provide a user-friendly experience that allows for a pragmatic and in-depth learning experience.

### SUMMARY OF THE DISCLOSURE

This disclosure relates to a cyber learning management environment that provides an interface for stakeholders of a course to utilize virtual machines and virtual networks to provide a hand-on environment that can engage students in simulated computing scenarios that can facilitate deeper and more intuitive learning of computing concepts.

### BRIEF DESCRIPTION OF THE DRAWINGS

FIG. 1 illustrates an exemplary cyber learning management environment according to examples of the disclosure.

FIG. 2 illustrates an exemplary core of a cyber learning computing environment according to examples of the disclosure.

FIG. 3 illustrates an exemplary grading system according to examples of the disclosure.

FIG. 4 illustrates an exemplary asset library module according examples of the disclosure.

FIGS. 5a-5d illustrate exemplary user interfaces of the cyber learning computing environment according to examples of the disclosure.

### DETAILED DESCRIPTION

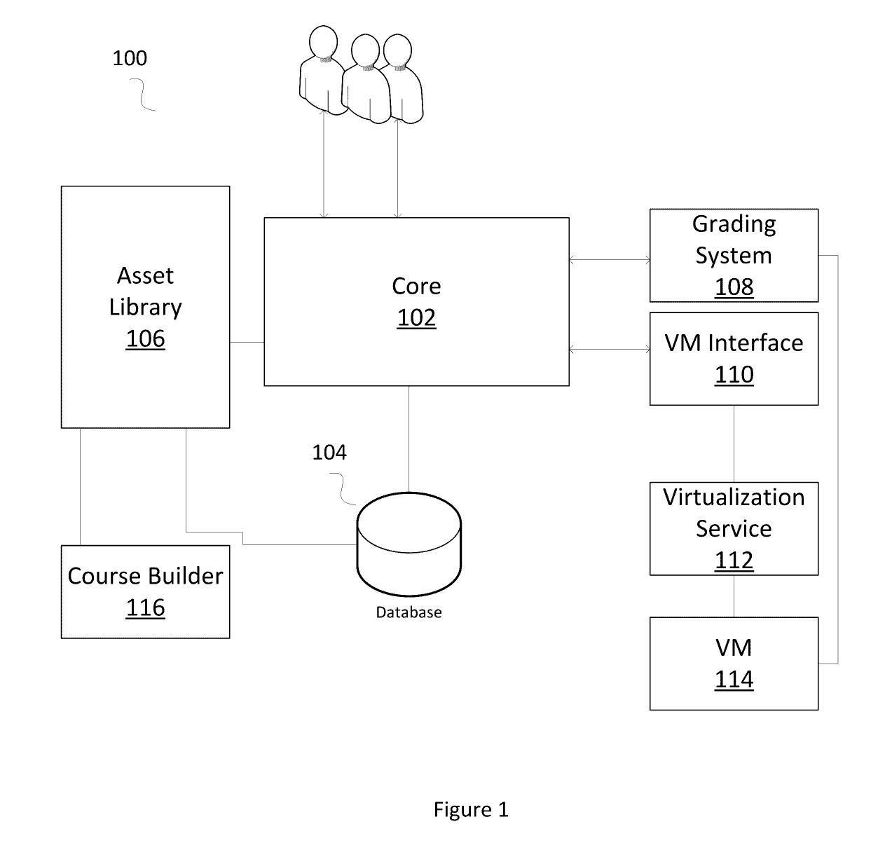

In order to allow users of a cyber learning course to access virtual machines and virtual networks, thus providing them a hands-on learning experience, a system that provides an interface between the users on one end, and the virtual machines and virtual networks needed to simulate real-world computing environments is needed. FIG. 1 illustrates an exemplary cyber learning management environment according to examples of the disclosure.

It should be understood that the system in FIG. 1 is an example system. Each component of the system may not be required for the system to operate and the disclosure should not be construed as requiring that each and every component illustrated in FIG. 1 be required.

The system 100 of FIG. 1 can include a core 102, a database 104, an asset library module 106, a grading system 108, a virtual machine (VM) interface 110, a virtualization service 112, and virtual machines 114. The system 100 can be accessed and manipulated via the internet, therefore allowing users/clients to access the system from their home/personal computing device.

As illustrated in FIG. 1, the computing system 100 can include a core 102. Core 102 can act as the central mechanism that displays information to the user. Core 102 can provide an application programing interface (API) for users to interact with the system. As an example, core 102 can provide the user interface necessary for user authentication, displaying of student grades, facilitation of course selection, etc. The core 102 can, in some examples, include the logic necessary for analyzing grades and user activity, which can be provided in reports to the students or other stakeholders of a particular course. The core 102 can interact with a database 104 to store content for courses, user information and roles, and grades. The user interface is the primary means for users to interact with Ginkgo and its components. As will be discussed further below, the core 102 can support the creation of linear and non-linear courses. Linear courses can include courses in which the student must complete each lesson in the order provided. Non-linear courses can include course that let the student complete exams to skip material they already know.

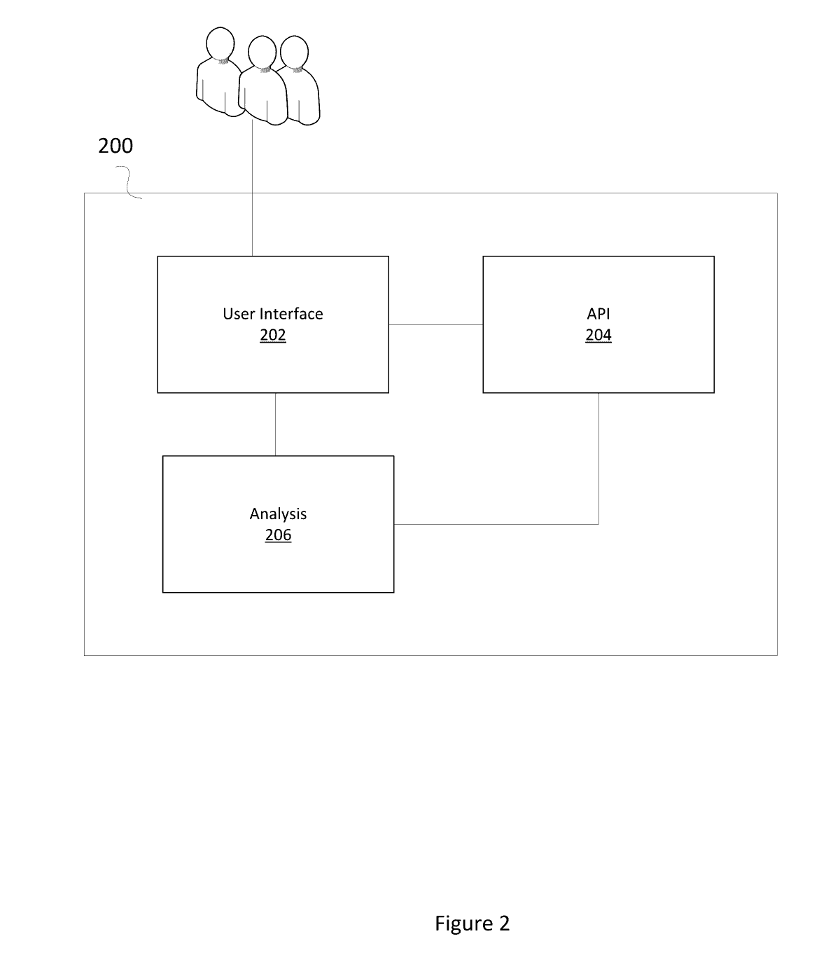

FIG. 2 illustrates an exemplary core of a cyber learning management system according to examples of the disclosure. As illustrated in FIG. 2, the core 200 can include a user interface 202. The user interface 202 can facilitate a user or client's interaction with the system. As an example, the user interface 202 can generate graphical user interfaces that allow the user to command the system, authenticate their identity to the system, and otherwise use the system for the purpose that they wish to achieve. Some examples of user interfaces provided by the system 100 are discussed further below.

The user interface 202 can accept inputs from a user. As one example, the user interface can allow for a user to login and authenticate their identity to the system. The core 200 can use that login information to determine the role of the user, and the manner in which the user can manipulate the system which can be based on the determined role.

As an example, roles can include site administrators, course creators, instructors, course reviewers, students, and proctors. A site administrator can access the system 100 via the user interface to perform such tasks as managing users, configuring the site, providing system alerts to other users of the system, managing the roles of the authorized users, managing different user groups within the system, and managing user accounts. In some examples, the site administrator can also customize the user interfaces by changing the style (color, location on screen, etc.) of those interfaces using a CSS style sheet.

The course creator role is reserved for those users that generate courses to be administered by the system 100. A course creator can build a course, setup a course design, generate grading criteria for the course, design virtual machine environments that will be used with the course, and generate content to be part of the asset library module 106 (discussed further below). Course creators can also interact with the system 100 via the user interface to test and debug the course that they are creating prior to having the course made available to others on the system.

The course reviewer role is reserved for those users who may not create or consume courses, but require the ability to review student performance of those students who are taking the courses provided by the system 100. A course reviewer can monitor student progress through the courses available on the system, receive course exam and exercise reports, and review grades received by students enrolled in the various courses. Students of a course can be put into a “user group,” and a course reviewer can have the ability to monitor student's progress based on their membership in a user group.

The proctor role, allows for an individual to access the system 100 so that they can release exams to students at pre-determined times, communicate with the instructor of a course before, during, or after an exam, communicate with students, and also monitor student conduct on the system during the administration of an exam.

The instructor role, allows for an individual to access the system 100 so that they can communicate with students, monitor student progress, troubleshoot technical issues with the course, view student progress, view exam results, and provide feedback to the students in their courses.

The student role is reserved for the users who are the primary consumers of the content generated by the course creator. The students can interact with the system 100 to take learning exercises associated with a course, take exams, generate notes based on the content of the courses, watch and listen to videos created by the course creator, perform research relating to topics pertinent to the courses they are taking, and read resources related to the courses they are taking.

The system 100 can provide access to the materials and content contained within the system based on the role of the user that can be identified during the login/authentication process.

Returning to FIG. 2, the core 200 can also include an application program interface (API) 204. API 204 can interface with other computing environments external to the system 100. As an example, API 204 can include a learning tools interoperability interface that allows the system 100 to interface with external learning management systems such as Blackboard©, Moodle©, etc. For instance, if a customer of system 100 wanted to employ the functionality of the system, but were already utilizing a commercial learning management system, the API 204 could interface with that system to transfer any necessary data (such as student grades) to the external learning management system.

In one example, students could utilize API 204 to access the system 100 from a commercial learning management system. Rather than directly interfacing with the system via the user interface 202 as discussed above, the interaction that would normally be facilitated by the user interface could instead be conducted via an external learning management system that interfaced with the system 100 via the API 204.

In another example, users of the course could interact with the system 100 via the user interface 202, however information based on the interaction with the system 100 could be transmitted to the external learning management system via the API 204.

API 204 can also receive data from the user interface 202. In one example, a user can enter their login information via the user interface 202. The login information can then be sent to API 204 wherein an authentication process can be initiated. The API 204 can communicate with a database 104 to compare the user's login information with information stored in the database. If a match occurs, the user can then be allowed to access the system in accordance with their role.

The core 200 can also receive data from the grading system 108 (discussed in detail below) and analyze the data using analysis module 206. The analysis module can perform analysis on data provided by the grading system. Example analysis performed by the analysis module 206 include the effectiveness of test questions, how they are used, percentage of correct answers on particular questions, and other information that can assist a course creator in refining the course. The analysis module 206 can also access database 104 to retrieve data to generate reports on the system.

Returning to FIG. 1, the system 100 can also include a grading system 108. Grading system 108 can provide auto-grading functionality to the system 100. Grading system 108 can support the grading of user interactions within the virtual environments and can be designed to bring user interactions within complex virtual scenarios into the system 100 as a gradable object.

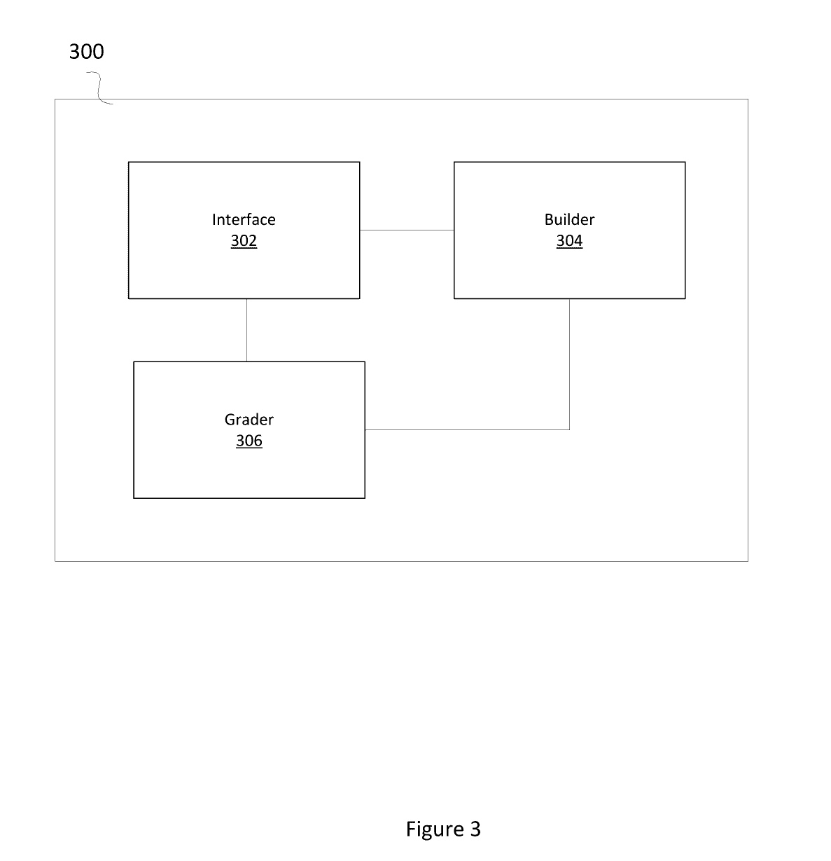

FIG. 3 illustrates an exemplary grading system according to examples of the disclosure. Grading system 300 can include a builder unit 304 and a grader unit 306. The builder unit 302 can be responsible for building the criteria that will be used to assess student performance in the virtual machine simulation environment. The builder unit 304 can receive data from the core that includes criteria provided by the course creator that will assess whether a student has successfully completed certain task within the virtual machine environment. For instance, a course creator can require that a student generate a particular text file with program code as part of a course. The course creator can also specify the criteria by which that text file will be analyzed to determine if the student has correctly completed the lab objectives.

The grader unit 306 can use the criteria provided by the builder unit 304 and a binary tree algorithm to process the gradable content sent to it from the virtual machine environment and appropriately score the gradable input. As will be discussed in detail below, an agent running on the virtual machines can be used to parse user input and program logs into a format that can be consumed by the grader unit 306.

The grading system 300 can also include an interface unit 302. The interface unit can receive data from the core 102 and also transmit data to the core. In one example, the interface unit 302 can receive grading criteria from the core generated by the course creator and can transmit scores based on the grading of the course to the core to be transmitted to various stakeholders of a course.

Returning to FIG. 1, the system 100 can also include a virtual machine interface 108. Virtual machine interface 108 can facilitate the interaction between the users and the virtual machines to be used by the users as part of the cyber learning course. The virtual machine interface 108 can clone virtual machines, create virtual networks, deploy virtual machines for exams and exercises in private networks, as well as virtual machines for experimentation. Virtual machine interface 108 can install files on virtual machines provided by the core 102, execute configuration scripts, retrieve files from the virtual machines, and destroy virtual machines and virtual networks when they are no longer needed.

The virtual machine interface 108 can also configure the virtual machine environment to execute various simulated scenarios that may be part of the course, and can record a student's interaction with the virtual machine in those simulated scenarios. The recorded data can then be sent to the grading system 106 to be graded.

System 100 can also include a virtualization service 112. Virtualization service 112 can serve as the application program interface of the virtual machines 114. Virtualization service 112 can receive the specification of the virtual machines 114 to be built as part of the course or exercise, and can convert those specifications into a virtual machine that it can build. In some examples, virtualization service 112 can be part of the system 100 as illustrated in FIG. 1. In other examples, virtualization service 112 can be operated by a third-party service such as VMware© that can receive the specification of the virtual machines to be built by the core 102 and can build the virtual machines 114 accordingly.

In some examples, each student taking a course or exam can utilize their own individual virtual machine or virtual network to execute a course or exam. In this way, rather than having to share a laboratory environment, or work at the same time, students can run through a course as an individual on their own time.

Returning to FIG. 1, system 100 can include an asset library module 106. Asset library module 106 can facilitate the creation and reuse of course content. Course creators can utilize asset library module 106 to create course content, and tag the content in the asset library module 106 such that a user can search and retrieve the content by searching for tags, by learning objective, by asset type (Rich Text, PDF, JPG, etc.), or by asset title. The tagging model described above allows course creators to generate courses and curriculums from the asset library module 106 by mixing and matching content modules as needed. The asset library module can also provide models for learning management system content (i.e., HTML, text, image formats, video formats, etc.,) and can translate user generated content into course modules for the core 102 to render as courses. The asset library module 106 can, in some examples, consume markup language files such as XML, using a defined schema for programmatic or bulk content loading. In some examples, the asset library module 106 can store its content in database 104, using its own table structure.

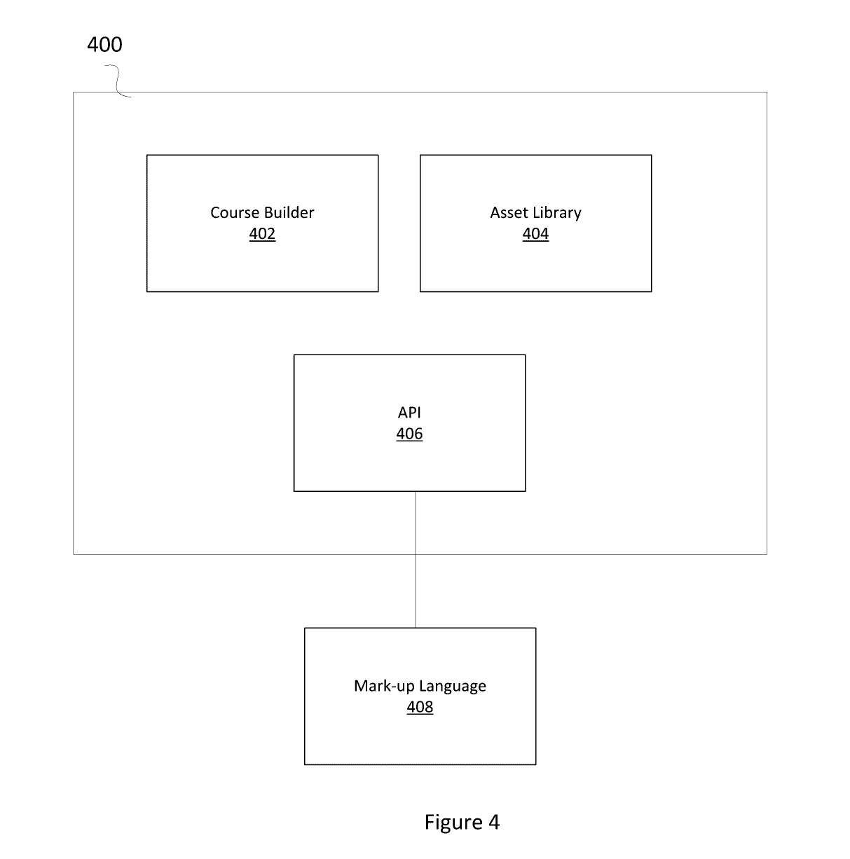

FIG. 4 illustrates an exemplary asset library module according to examples of the disclosure. The asset library module 400 can include a course builder 402, an asset library 404, and an application program interface (API) 306 that can receive markup language 408 as an input.

The asset library 404 can store content that can be used to build courses. Examples of content can include, course texts, course videos, slide presentations, pdf files, questions, glossaries, dictionaries, etc. The asset library 404 can allow users to store content and create metadata to be attached to each item of content. The metadata attached to the content can “tag” the content so that other users of the system 100 can search for objects in the asset library by searching for tags. A user can search for a tag, and the asset library 404 can return content that possess tags pertinent to the user's search.

The asset library module 400 can also include a course builder 402. The course builder 402 allows a course creator to assemble pieces of content stored within the asset library to build a desired course. The course creator can assemble pieces of content by searching for tags relating to the course they want to create, finding relevant content, and then assembling the pieces of content into a course. Once a course creator has assembled the content to build a course, the course builder 402 can then publish the course, making it available to users who wish to access it.

One advantage of using content objects to build courses is that if an individual object is modified, each course can instantly and automatically reference the modified content object. This can save the course creator from having to modify every course that references a content object, if that object is modified.

The asset library module 400 can include an application program interface 406. The API 406 can receive user generated markup language files and generate content to be populated in the asset library 406. In one example, as discussed above, course creators can build content and courses using the user interface module located in the core 102. Additionally, in some examples, the course creator can choose to generate content via creating markup language files 408. In some examples, the markup language used can be XML. The API 406 can ingest the markup language files 408, and generate course content in the asset library 406.

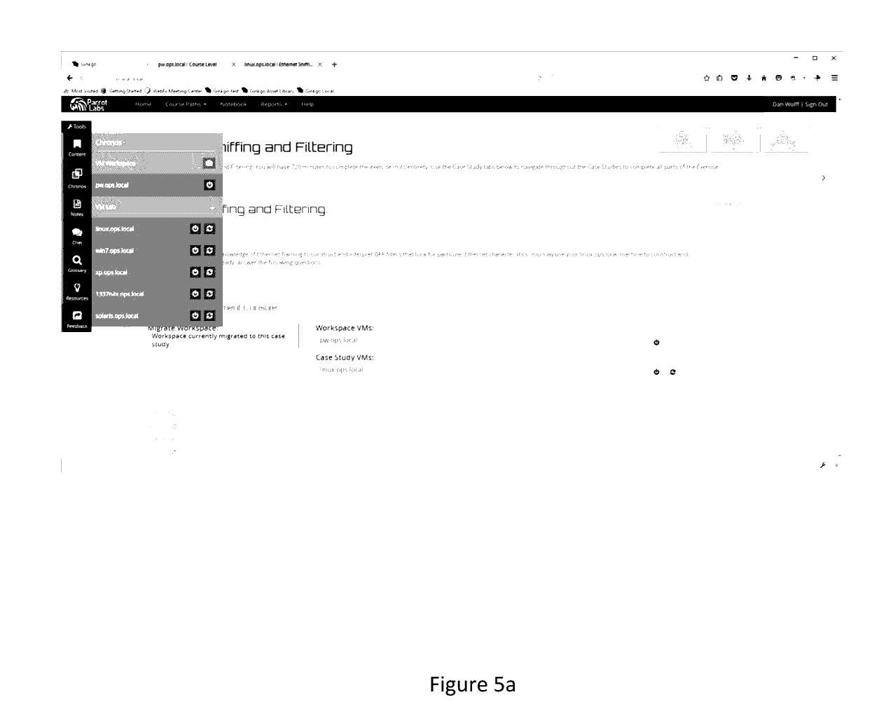

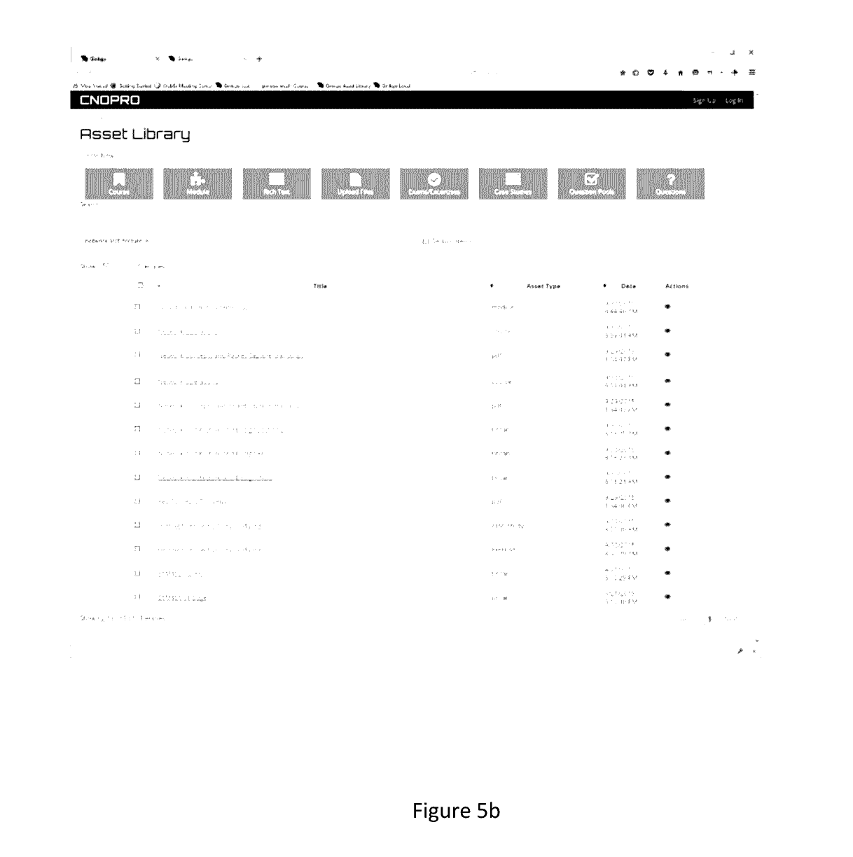

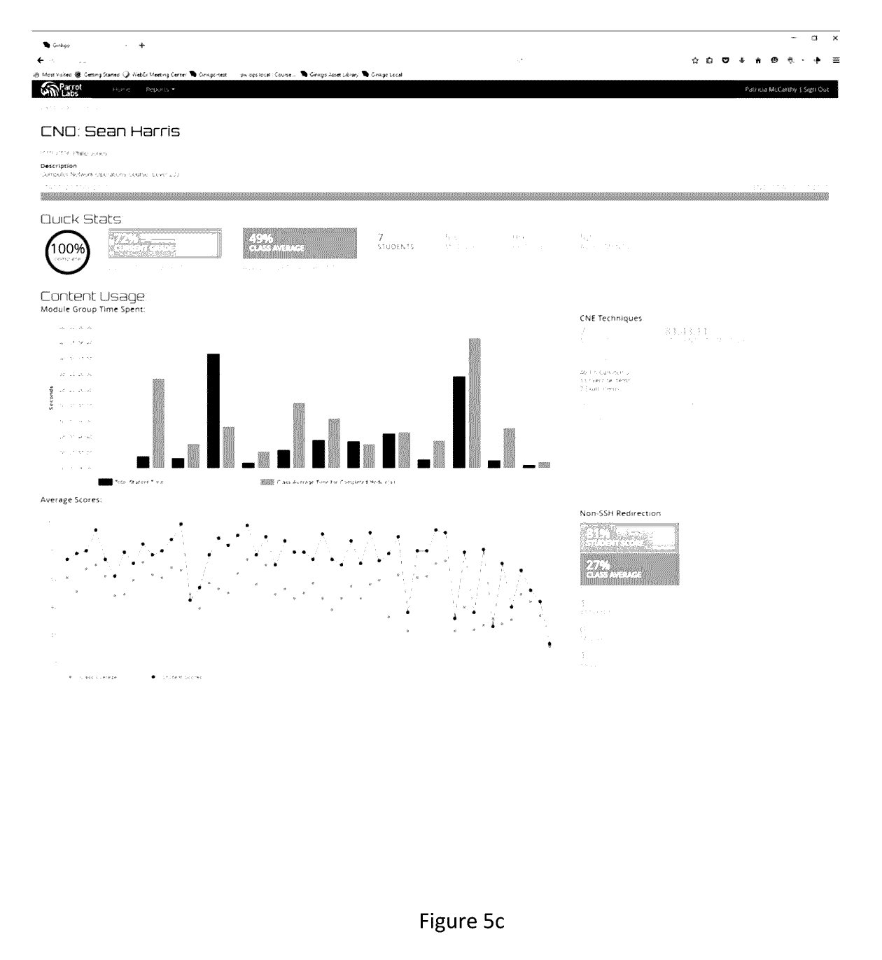

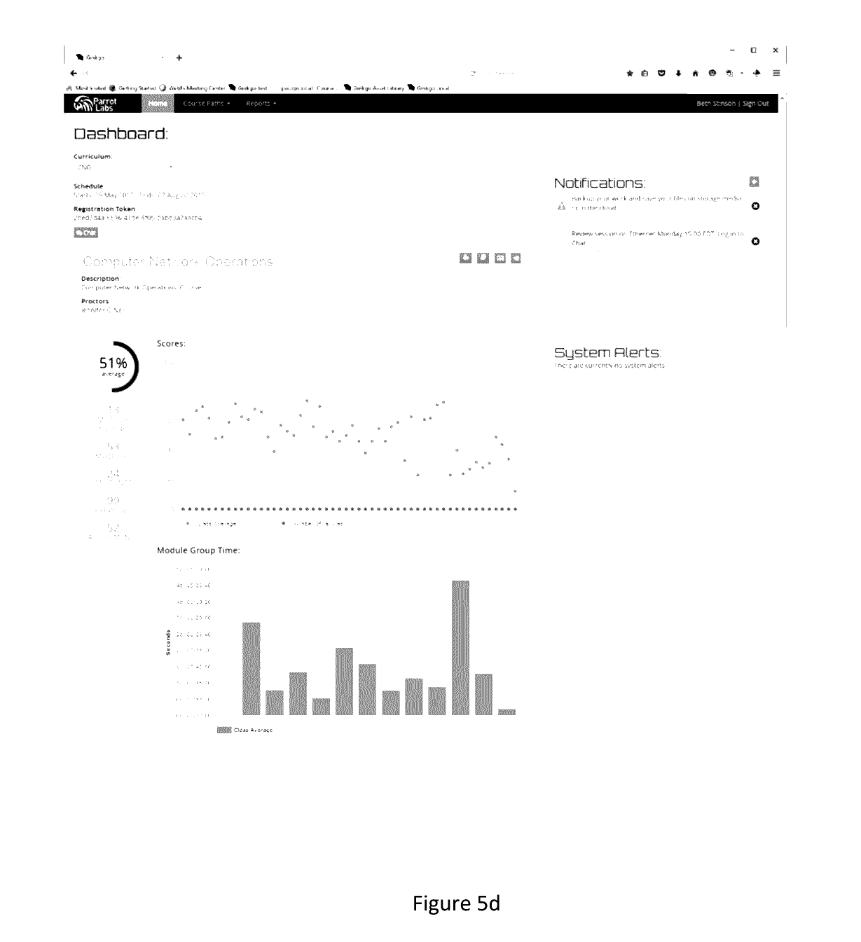

FIGS. 5a-5d illustrate exemplary user interfaces of the cyber learning computing environment according to examples of the disclosure.

FIG. 5a illustrates an exemplary student user interface according to examples of the disclosure. The example of FIG. 5a illustrates an example screen shot in which a student is able to select a virtual environment to enter based upon the courses they are enrolled in as well as past virtual environments that they have visited.

FIG. 5b illustrates an exemplary course creator user interface according to examples of the disclosure. The example of FIG. 5b illustrates an example screen shot in which a course creator is able to choose from objects in an asset library as discussed above to be included in the course that they are creating.

FIG. 5c illustrates an exemplary course reviewer user interface according to examples of the disclosure. The example of FIG. 5c illustrates an example screen shot in which a course reviewer is able to view the scores of the students taking a particular course, as well as other metrics that are indicative of student performance.

FIG. 5d illustrates an exemplary instructor dashboard according to example of the disclosure. The example of FIG. 5d illustrates an example screen shot in which a course instructor is able to review student scores as well as the amount of time it is taking students to complete modules within the course.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Therefore, according to the above, some examples of the disclosure are directed to a system comprising: a core that accepts a user input and that loads a cyber-course created for a cyber-learning environment based on the user input, a virtualization platform that builds at least one virtual computing environment based on the loaded cyber-course, and a grading module that generates at least one grading criterion based on the loaded cyber-course, that receives information from the virtualization platform based on user interaction with the virtual computing environment, and that compares the received information and the generated grading criterion. Additionally or alternatively to one or more of the examples disclosed above, in some examples the system can further comprise: an asset library comprising at least one asset, and a course builder that generates the cyber-course based on the asset. Additionally or alternatively to one or more of the examples disclosed above, in some examples the course builder comprises an application program interface that receives user-generated markup files and that generates content to be populated in the asset library based on the received user-generated markup files. Additionally or alternatively to one or more of the examples disclosed above, in some examples the grading module comprises a builder module that receives at least one criterion based on the loaded cyber-course and that generates a binary decision tree based on the received criterion. Additionally or alternatively to one or more of the examples disclosed above, in some examples the user's interaction with the virtual computing environment is assessed using the generated binary decision tree, and wherein a score is generated based on the assessment. Additionally or alternatively to one or more of the examples disclosed above, in some examples the score is transmitted to the core to be accessed by at least one user of the cyber-learning environment. Additionally or alternatively to one or more of the examples disclosed above, in some examples the system comprises multiple virtual environments corresponding to multiple users of the cyber-course. Additionally or alternatively to one or more of the examples disclosed above, in some examples at least one virtual computing environment comprises a virtual machine. Additionally or alternatively to one or more of the examples disclosed above, in some examples at least one virtual computing environment comprises a virtual network.

Some examples of the disclosure are directed to a method of receiving a user input, loading a cyber-course created for a cyber-learning environment based on the received user input, building at least one virtual computing environment based on the loaded cyber-course, generating at least one grading criterion based on the loaded cyber course, receiving information pertaining to the user's interaction with the virtual computing environment, and comparing the received information and the generated grading criterion. Additionally or alternatively to one or more of the examples disclosed above, in some examples, the method comprises generating the cyber-course based on at least one asset contained in an asset library. Additionally or alternatively to one or more of the examples disclosed above, in some examples, the method comprises receiving at least one user-generated markup file and generating content to be populated in the asset library based on the at least one user-generated markup file. Additionally or alternatively to one or more of the examples disclosed above, in some examples, the method comprises receiving at least one criterion based on the loaded cyber-course and generating a binary decision tree based on the received criterion. Additionally or alternatively to one or more of the examples disclosed above, in some examples, the method comprises assessing the user's interaction with the virtual computing environment using the generated binary decision tree, and generating a score based on the assessment. Additionally or alternatively to one or more of the examples disclosed above, in some examples, the method comprises transmitting the score to at least one user of the cyber-learning environment. Additionally or alternatively to one or more of the examples disclosed above, in some examples, the method comprises multiple virtual environment corresponding to multiple users of the cyber-course. Additionally or alternatively to one or more of the examples disclosed above, in some examples the at least one virtual computing environment comprises a virtual machine. Additionally or alternatively to one or more of the examples disclosed above, in some examples the at least one virtual computing environment comprises a virtual network.

Some examples of the disclosure are directed to a non-transitory computer readable storage medium having stored thereon a set of instructions that when executed by a computing device, cause the computing device to: receive a user input, load a cyber-course created for a cyber-learning environment based on the received user input, build at least one virtual computing environment based on the loaded cyber-course, generate at least one grading criterion based on the loaded cyber course receive information pertaining to the user's interaction with the virtual computing environment, and compare the received information and the generated grading criterion. Additionally or alternatively to one or more of the examples disclosed above, the computing device is caused to: generate the cyber-course based on at least one asset contained within an asset library. Additionally or alternatively to one or more of the examples disclosed above, the computing device is caused to: receive at least one user-generated markup file and generate content to be populated in the asset library based on the at least one user-generated markup file. Additionally or alternatively to one or more of the examples disclosed above, the computing device is caused to: receive at least one criterion based on the loaded cyber-course and generate a binary decision tree based on the received criterion. Additionally or alternatively to one or more of the examples disclosed above, the user's interaction with the virtual computing environment is assessed using the generated binary decision tree, and wherein a score is generated based on the assessment. Additionally or alternatively to one or more of the examples disclosed above the score is transmitted to at least one user of the cyber-learning environment. Additionally or alternatively to one or more of the examples disclosed above the at least one virtual environment corresponds to a number of users of the cyber-course. Additionally or alternatively to one or more of the examples disclosed above the at least one virtual computing environment comprises a virtual machine. Additionally or alternatively to one or more of the examples disclosed above the at least one virtual computing environment comprises a virtual network.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

What is claimed is:

1. A system comprising:
a core that accepts a user input and that loads a cyber-course created for a cyber-learning environment based on the user input,
a virtualization platform that builds at least one virtual computing environment based on the loaded cyber-course, and
a grading module that generates at least one grading criterion based on the loaded cyber-course, that receives information from the virtualization platform based on user interaction with the virtual computing environment, and that compares the received information and the generated grading criterion.

2. The system of claim 1 comprising:
an asset library comprising at least one asset, and
a course builder that generates the cyber-course based on the asset.

3. The system of claim 2, wherein the course builder comprises an application program interface that receives user-generated markup files and that generates content to be populated in the asset library based on the received user-generated markup files.

4. The system of claim 1, wherein the grading module comprises a builder module that receives at least one criterion based on the loaded cyber-course and that generates a binary decision tree based on the received criterion.

5. The system of claim 4, wherein the user's interaction with the virtual computing environment is assessed using the generated binary decision tree, and wherein a score is generated based on the assessment.

6. The system of claim 5, wherein the score is transmitted to the core to be accessed by at least one user of the cyber-learning environment.

7. The system of claim 1, comprising multiple virtual environments corresponding to multiple users of the cyber-course.

8. The system of claim 1, wherein the at least one virtual computing environment comprises a virtual machine.

9. The system of claim 1, wherein the at least one virtual computing environment comprises a virtual network.

10. A method comprising:
receiving a user input,
loading a cyber-course created for a cyber-learning environment based on the received user input,
building at least one virtual computing environment based on the loaded cyber-course,
generating at least one grading criterion based on the loaded cyber course, receiving information pertaining to the user's interaction with the virtual computing environment, and
comparing the received information and the generated grading criterion.

11. The method of claim 10, comprising:
generating the cyber-course based on at least one asset contained in an asset library.

12. The method of claim 11, comprising:
receiving at least one user-generated markup file and generating content to be populated in the asset library based on the at least one user-generated markup file.

13. The method of claim 10, comprising: receiving at least one criterion based on the loaded cyber-course and generating a binary decision tree based on the received criterion.

14. The method of claim 13, comprising assessing the user's interaction with the virtual computing environment using the generated binary decision tree, and generating a score based on the assessment.

15. The method of claim 14, comprising transmitting the score to at least one user of the cyber-learning environment.

16. The method of claim 10, comprising multiple virtual environment corresponding to multiple users of the cyber-course.

17. The method of claim 10, wherein the at least one virtual computing environment comprises a virtual machine.

18. The method of claim 9, wherein the at least one virtual computing environment comprises a virtual network.

19. A non-transitory computer readable storage medium having stored thereon a set of instructions that when executed by a computing device, cause the computing device to:
receive a user input,
load a cyber-course created for a cyber-learning environment based on the received user input,
build at least one virtual computing environment based on the loaded cyber-course,
generate at least one grading criterion based on the loaded cyber course
receive information pertaining to the user's interaction with the virtual computing environment, and
compare the received information and the generated grading criterion.

20. The non-transitory computer readable storage medium of claim 19, wherein the processor is caused to generate the cyber-course based on at least one asset contained within an asset library.

21. The non-transitory computer readable storage medium of claim 20, wherein the processor is caused to:
receive at least one user-generated markup file and generate content to be populated in the asset library based on the at least one user-generated markup file.

22. The non-transitory computer readable storage medium of claim 19, wherein the processor is caused to receive at least one criterion based on the loaded cyber-course and generate a binary decision tree based on the received criterion.

23. The non-transitory computer readable storage medium of claim 22, wherein the user's interaction with the virtual computing environment is assessed using the generated binary decision tree, and wherein a score is generated based on the assessment.

24. The non-transitory computer readable storage medium of claim 19, wherein the score is transmitted to at least one user of the cyber-learning environment.

25. The non-transitory computer readable storage medium of claim 19, wherein the at least one virtual environment corresponds to a number of users of the cyber-course.

26. The non-transitory computer readable storage medium of claim 19, wherein the at least one virtual computing environment comprises a virtual machine.

27. The non-transitory computer readable storage medium of claim 19, wherein the at least one virtual computing environment comprises a virtual network.
